(19) United States
(12) Patent Application Publication
(10) Pub. No.: US 2006/0269055 A1
(43) Pub. Date: Nov. 30, 2006

(54) Method and apparatus for improving performance and security of DES-CBC encryption algorithm

(75) Inventors: Shawn Patrick Mullen, Buda, TX (US); Sankara Subbiah Muthukrishnan, Tirunelveli (IN); Sriram M. Ramanathan, Durham, NC (US); Anandha S. Srinivasan, Chengalpattu (IN); James Stanley Tesauro, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/138,831

(22) Filed: May 26, 2005

(51) Int. Cl. H04K 1/06

(52) U.S. Cl. 380/37

(57) ABSTRACT

Method and apparatus for transforming data in a data processing system. A first portion of a block of data is transformed using a first key having a first number of bits, and a second portion of the block of data is transformed using a second key having a second number of bits different than the first number of bits. One of the first and second keys provides an increase in transformation speed while the other of the first and second keys provides an enhanced degree of data security.

### BACKGROUND OF THE INVENTION

1. Technical Field

The present invention relates generally to the data processing field and, more particularly, to a method and apparatus for improving performance and security of DES-CBC encryption algorithm.

2. Description of Related Art

Encryption is the transformation of data to a form which cannot be read without the appropriate knowledge or key. Encryption is commonly used in the data processing field to prevent unauthorized persons from accessing confidential data

One well-known encryption technique is DES (Data Encryption Standard). DES is a block cipher, i.e. it acts on a fixed length block of plaintext and converts the plaintext into a block of ciphertext of the same size by using a secret key. In DES, the fixed block size of plaintext is 64 bits. Decryption is performed by applying the reverse transformation to the block of ciphertext using the same secret key.

In order to encrypt messages that are longer than a single block, several modes of operation are known. In the CBC (Cipher Block Chaining) mode of operation, each block of plaintext is XORed with the previous ciphertext block before being encrypted. Each ciphertext block is, therefore, dependent on all plaintext blocks that have been encrypted up to that point.

FIG. 4 is a block diagram that explains the conventional DES-CBC algorithm to assist in understanding the present invention. The diagram is generally designated by reference number 400, and in the Figure, Eₖ represents the encryption key algorithm, P₁, P₂, . . . Pₙ are plaintext inputs (in number of bits equal to the key length), C₁ , C₂ . . . Cₙ are ciphertext outputs and IV is an Initial Vector.

As shown in FIG. 4, except to produce the first block of ciphertext C₁, the input to the encryption algorithm Eₖ is the XOR of the current plaintext block and the preceding ciphertext block. For example, as shown in FIG. 4, ciphertext block C₁ is XORed with plaintext block P₂ to produce ciphertext block C₂. As also shown in FIG. 4, the same encryption key (Eₖ) is used for each block. Initialization vector (IV) is XORed with the first block of plaintext P₁ to produce ciphertext block C₁ (inasmuch as there is no preceding ciphertext block). The IV must be known to both the sender and receiver and is often a random number. For maximum security, the IV should be protected as well as the key.

As illustrated in FIG. 4, with the conventional DES-CBC algorithm, processing of the current plaintext block is chained. Since the input to the encryption function for each plaintext block bears no fixed relationship to the plaintext block, repeating patterns of the block are not exposed.

The encryption algorithm can be expressed as:
Cₙ=Eₖ[Cₙ₋₁ΘPₙ]

For decryption, each ciphertext block is passed through the decryption algorithm. The result is XORed with the preceding ciphertext block to produce the plaintext block. On decryption, the IV is XORed with the output of the decryption algorithm to recover the first block of plaintext.

The decryption algorithm can be expressed as:
Pₙ=Cₙ₋₁ΘDₖ[Cₙ]

DES, using 64-bit key, is fast. However, 64-bit key may not provide the degree of security required for many applications. In order to provide increased security, 128-bit key can be used.

Although 128-bit key DES provides a user with increased security, it is a slower process than using 64-bit key DES. A user must therefore decide whether a particular encryption application should be relatively fast but less secure, or relatively slow but more secure.

There is, accordingly, a need for a method and apparatus for improving the performance and security of transformation algorithms, such as the DES-CBC encryption/decryption algorithm, so as to provide a relatively high transformation speed while maintaining an enhanced degree of data security.

### SUMMARY OF THE INVENTION

The present invention provides a method and apparatus for transforming data in a data processing system. A first portion of a block of data is transformed using a first key having a first number of bits, and a second portion of the block of data is transformed using a second key having a second number of bits different than the first number of bits. One of the first and second keys provides an increase in transformation speed while the other of the first and second keys provides an enhanced degree of data security.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation that depicts a network of data processing systems in which the present invention may be implemented;

FIG. 2 is a block diagram of a data processing system that may be implemented as a server according to a preferred embodiment of the present invention;

FIG. 3 is a block diagram of a data processing system that may be implemented as a client according to a preferred embodiment of the present invention;

FIG. 4 is a block diagram that explains the conventional DES-CBC algorithm to assist in understanding the present invention;

FIG. 5 is a block diagram that explains a DES-CBC algorithm according to a preferred embodiment of the present invention;

FIG. 6 is a flowchart that illustrates a method for encrypting data according to a preferred embodiment of the present invention; and

FIG. 7 is a flowchart that illustrates a method for decrypting encoded data according to a preferred embodiment of the present invention.

### DETAILED DESCRIPTION OF THE PREFERRED EMBODIMENT

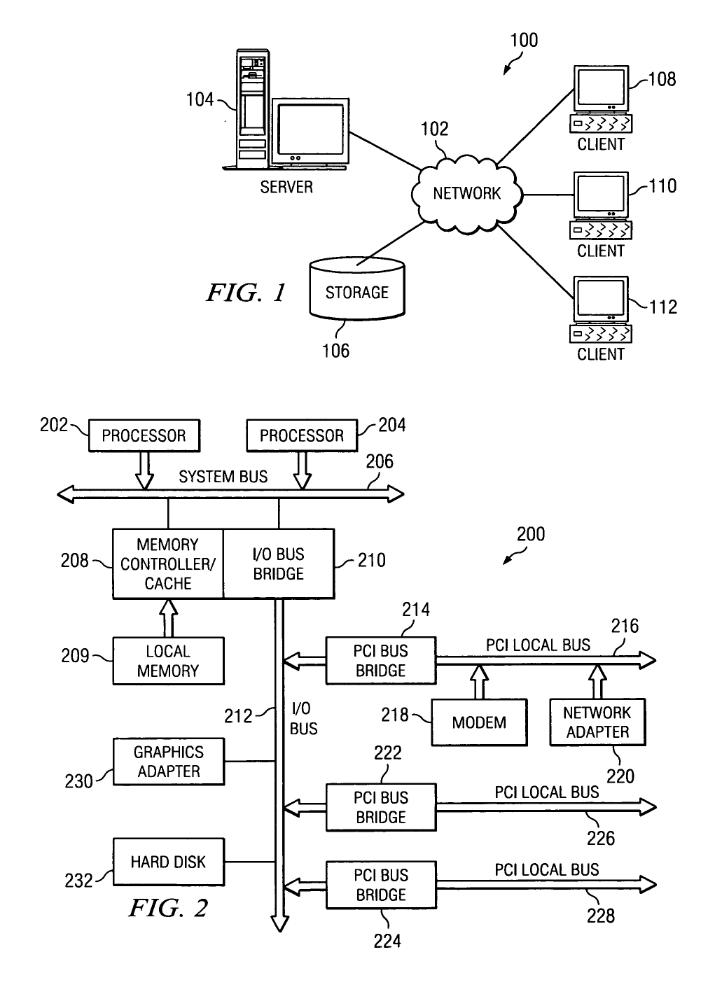

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

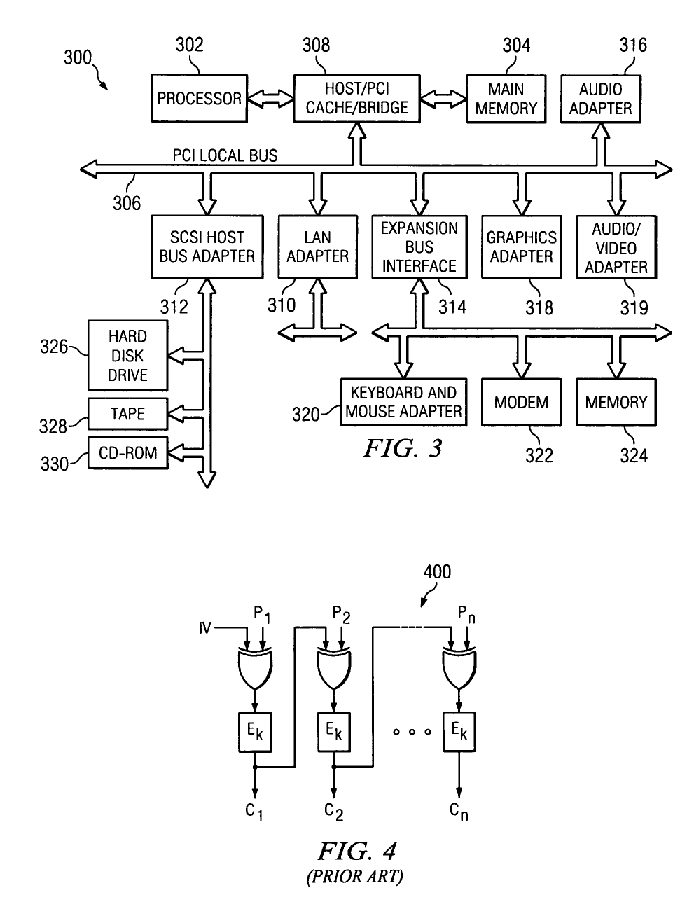

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides a method and apparatus for transforming (encrypting or decrypting) data sent from one location to another, for example, over a data processing system network such as network 102 in FIG. 1. In particular, the present invention provides a method and apparatus for improving the performance and security of encryption/decryption algorithms, such as the DES-CBC encryption/decryption algorithm, so as to provide a relatively high encryption/decryption speed while maintaining an enhanced degree of data security. The invention recognizes that using 64-bit DES-CBC to encrypt data is not as secure as using 128-bit DES-CBC, whereas 128-bit DES-CBC is not as fast as 64-bit DES-CBC. In general, n-bit DES-CBC is not as secure as 2n-bit DES-CBC whereas 2n-bit DES-CBC is not as fast as n-bit DES-CBC.

In a continuous stream of data being sent from one party to another party across a network, such as network 102 in FIG. 1, if one portion of a block of data is encrypted with a stronger key (for example, 128 bit) and the remaining portion of the block of data is encrypted with a relatively weaker key (for example, 64 bit), data loss can be minimized even if the weaker key is broken. At the same time, by using the combination of a weaker key (key with fewer bits) and a stronger key (key with more bits), performance impact for encryption/decryption can be reduced.

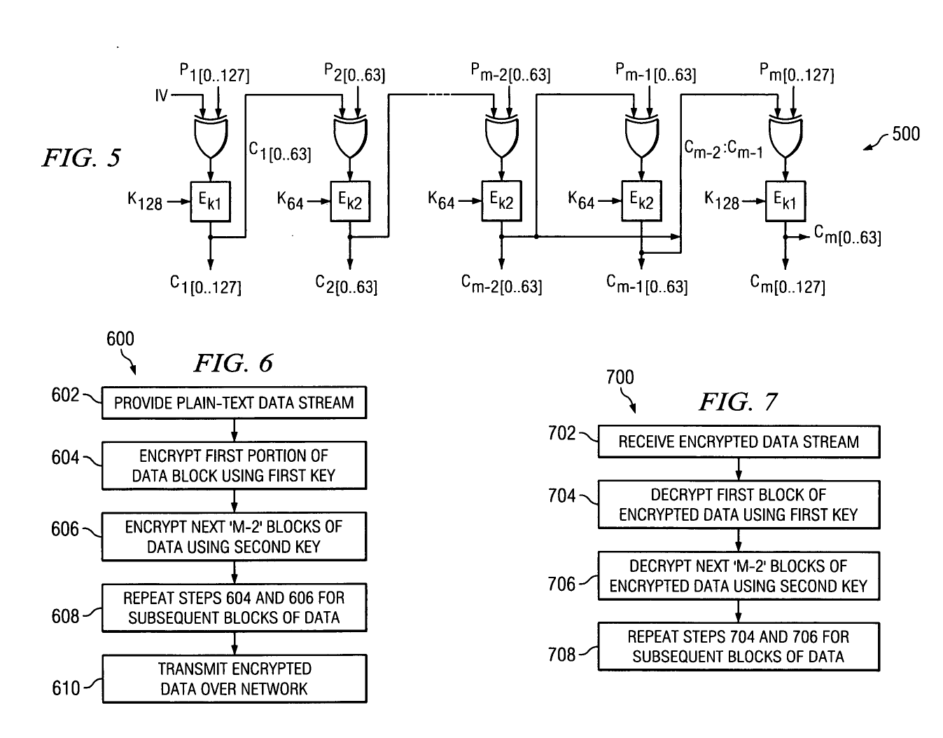

FIG. 5 is a block diagram that explains a DES-CBC algorithm according to a preferred embodiment of the present invention. In FIG. 5, Eₖ₁ is an algorithm that uses a 128-bit key (K₁₂₈). Only encryption key Eₖ₁ has an initialization vector (IV) of size 128-bit. Encryption algorithm Eₖ₂ uses a 64-bit key (K₆₄) and has no IV. Initial input to Eₖ₁ is the XOR of 128-bit plaintext P1_{[0 . . . 127]}. Output of Eₖ₁ is 128-bit cipher text C_{[0 . . . 127]}. Only the first 64 bits of the 128-bit ciphertext (C_{1[0 . . . 63]}) is used to XOR with P_{2[0 . . . 63]} and given as input to Eₖ₂. Then, the output of Eₖ₂ is used as in the conventional DES-CBC algorithm as described above in connection with FIG. 4. After a particular number (configurable parameter) of plaintext blocks are encrypted as shown (i.e. the number of blocks of plaintext encrypted with Eₖ₂), Eₖ₁ is used again to encrypt the next plaintext block. In particular, C_{M-2[0 . . . 63]} and C_{M-1[0 . . . 63]} are combined as a single 128-bit block (let C_{M-2} be the lower 64-bit part and let C_{M-1} be the upper 64-bit part) and XORed with the 128-bit plaintext block P_{M[0 . . . 127]} and given as input to Eₖ₁. This sequence is repeated until a complete message is encrypted.

Depending on the size of the message, the last block of plaintext may be encrypted with either Eₖ₁ or Eₖ₂. Necessary padding may be added to the input plaintext as in the conventional DES-CBC algorithm.

Decryption is carried out as in the conventional DES-CBC decryption process. Dₖ₁ and Dₖ₂ are used appropriately to decrypt the 128-bit blocks and 64-bit blocks of ciphertext.

FIG. 6 is a flowchart that illustrates a method for encrypting data according to a preferred embodiment of the present invention. The method is generally designated by reference number 600 and begins by providing a continuous stream of plaintext data to be encrypted (Step 602). A first portion of a block of plaintext data in the data stream is then encrypted using a first key having a first number of bits, for example, 128 bits (Step 604), and then subsequent M-2 blocks of plaintext data are encrypted using a second key having a second number of bits, for example, 64 bits (Step 606). The above sequence is then repeated for subsequent data blocks until the continuous stream of plaintext data has been encrypted (Step 608), and the encrypted data stream is then transmitted over a network (Step 610).

FIG. 7 is a flowchart that illustrates a method for decrypting encrypted data according to a preferred embodiment of the present invention. The method is generally designated by reference number 700 and begins by receiving a continuous stream of encrypted data (Step 702). The first block of encrypted data in the data stream is then decrypted using the first key used for encryption of the data block and having a first number of bits, for example, 128 bits (Step 704), and the subsequent M-2 blocks of encrypted data are decrypted using a second key used for encryption of the corresponding blocks of data and having a second number of bits, for example, 64 bits (Step 706). The above sequence is then repeated for subsequent blocks of data until the continuous stream of encrypted data has been decrypted (Step 708).

With the present invention, since 128-bit encryption is used to encrypt one block of 128-bit plaintext only for every M-2 blocks of 64-bit plaintext, the encryption method is faster than it would be if using 128-bit encryption only for the whole plaintext. Furthermore, since the 128-bit key is more secure than a 64-bit key, even if the 64-bit key is broken, the blocks of the message encrypted with the 128-bit key will still not be compromised.

The method and apparatus of the present invention provides a user with the flexibility to choose between strength of security and performance. For example, if stronger security is required, a smaller value for “M” may be chosen so that a bigger portion of the plaintext will be encrypted with the 128-bit key/algorithm. If performance is more important, a larger value for “M” may be chosen so that a greater portion of the plaintext will be encrypted with the 64-bit key/algorithm.

With the present invention also, the initialization vector is required only for the 128-bit encryption algorithm. Breaking a 128-bit IV is usually more difficult than breaking a 64-bit IV. As a result, the present invention also provides greater security for the initialization vector.

It should also be noted that although in the preferred embodiment described above, a 128-bit key algorithm and a 64-bit key algorithm are used in CBC, the invention is not so limited in that the invention can be practiced with any “m” bit key and “n” bit key combination of algorithms.

The present invention thus provides a method and apparatus for transforming data in a data processing system. A first portion of a block of data is transformed using a first key having a first number of bits, and a second portion of the block of data is transformed using a second key having a second number of bits different than the first number of bits. One of the first and second keys provides an increase in transformation speed while the other of the first and second keys provides an enhanced degree of data security.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for transforming a block of data, comprising:
transforming a first portion of a block of data using a first key having a first number of bits; and
transforming a second portion of the block of data using a second key having a second number of bits different than the first number of bits.

2. The method according to claim 1, wherein the first number of bits is greater than the second number of bits.

3. The method according to claim 2, wherein the first number of bits is twice the second number of bits.

4. The method according to claim 1, wherein the transforming steps are performed using a DES-CBC transformation algorithm.

5. The method according to claim 4, wherein the first number of bits is twice the second number of bits.

6. The method according to claim 5, wherein the first number of bits is 128 bits and the second number of bits is 64 bits.

7. The method according to claim 4, and further including repeating the transforming steps for subsequent data blocks of a stream of data blocks to transform the data stream.

8. The method according to claim 1, wherein the transforming comprises encrypting.

9. The method according to claim 1, wherein the transforming comprises decrypting.

10. Apparatus for transforming a block of data, comprising:
a first transforming mechanism for transforming a first portion of a block of data using a first key having a first number of bits; and
a second transforming mechanism for transforming a second portion of the block of data using a second key having a second number of bits different than the first number of bits.

11. The apparatus according to claim 10, wherein the first number of bits is twice the second number of bits.

12. The apparatus according to claim 10, wherein the first and second transforming mechanisms utilize a DES-CBC transformation algorithm.

13. The apparatus according to claim 12, wherein the first number of bits is 128 bits and the second number of bits is 64 bits.

14. The apparatus according to claim 12, wherein the first and second transforming mechanisms further transform subsequent data blocks of a stream of data blocks to transform the data stream.

15. The apparatus according to claim 10, wherein the first and second transforming mechanisms comprise first and second encrypting mechanisms.

16. The apparatus according to claim 10, wherein the first and second transforming mechanisms comprise first and second decrypting mechanisms.

17. A computer program product comprising a computer usable medium having computer usable program code for transforming a block of data, the computer program product comprising:
computer usable program code for transforming a first portion of a block of data using a first key having a first number of bits; and
computer usable program code for transforming a second portion of the block of data using a second key having a second number of bits different than the first number of bits.

18. The computer program product according to claim 17, wherein the computer usable program code for transforming a first portion of a block of data using a first key having a first number of bits comprises:
computer usable program code for transforming the first portion of the block of data using a DES-CBC transformation algorithm, and wherein the computer usable program code for transforming a second portion of the block of data using a second key having a second number of bits different than the first number of bits comprises:
computer usable program code for transforming the second portion of the block of data using the DES-CBC transformation algorithm.

19. The computer program product according to claim 17, wherein the computer usable program code for transforming a first portion of a block of data using a first key having a first number of bits comprises:
computer usable program code for encrypting a first portion of a block of data using a first key having a first number of bits; and wherein the computer usable program code for transforming a second portion of the block of data using a second key having a second number of bits different than the first number of bits comprises:
computer usable program code for encrypting a second portion of the block of data using a second key having a second number of bits different than the first number of bits.

20. The computer program product according to claim 17, herein the computer usable program code for transforming the first portion of the block of data using a DES-CBC transformation algorithm comprises:
computer usable program code for decrypting a first portion of a block of data using a first key having a first number of bits; and wherein the computer usable program code for transforming a second portion of the block of data using a second key having a second number of bits different than the first number of bits comprises:
computer usable program code for decrypting a second portion of the block of data using a second key having a second number of bits different than the first number of bits.
